(19) United States
(12) Patent Application Publication
(10) Pub. No.: US 2017/0112061 A1
(43) Pub. Date: Apr. 27, 2017

(54) GRAPHICAL YIELD MONITOR STATIC (PREVIOUS) DATA DISPLAY ON IN-CAB DISPLAY

(71) Applicant: CNH Industrial America LLC, New Holland, PA (US)

(72) Inventor: Andrew Meyer, Prospect Heights, IL (US)

(73) Assignee: CNH INDUSTRIAL AMERICA LLC, New Holland, PA (US)

(21) Appl. No.: 14/923,652

(22) Filed: Oct. 27, 2015

(51) Int. Cl. A01D 41/127; G06F 3/0482

(52) U.S. Cl. CPC A01D 41/1272; G06F 3/0482; A01D 41/06

(57) ABSTRACT

A yield monitoring system is provided for an agricultural harvester. The yield monitoring system has an in-cab display and at least one configurable user defined window operable to display at least two previously collected parameters simultaneously and comparatively in graphical format. The at least two previously collected parameters include previously collected data from at least one yield monitoring sensor or vehicle sensor. The in-cab display may have a menu allowing the choice of paired data sources to be viewed simultaneously and comparatively. Data sources may include quantity of crop yielded, moisture content of crop yielded, rate of flow of crop through the agricultural harvester, protein content of crop yielded, ground speed, speed of operation of the grain elevator, and height of the header above the ground.

### BACKGROUND OF THE INVENTION

1. Field of the Invention

The present invention relates to previously collected data for yield monitoring on an agricultural harvest vehicle, and, more particularly, to an in-cab display that allows the display of previously collected data for yield monitoring to be presented in graphical format along with vehicle data while the operator is still in the vehicle without requiring export and analysis on an external device.

2. Description of the Related Art

Combines are used to harvest agricultural crops such as corn, soybeans, wheat and other grain crops. As the combine is driven through crop fields, the combine cuts the crop, separates the desired crop from the undesired waste, stores the crop, and discards the waste. In order to accomplish this, the crop material is collected by a header and deposited into a feeder housing. The crop material is then transported upwardly and into the combine by a feed elevator located within the feeder housing. The crop material then passes through a threshing and separating mechanism, which may include a rotor, a threshing concave, a rotor cage, and a separating grate. As crop material passes through the threshing and separating mechanism, the grain is separated from the stalk material, commonly referred to as material other than grain (MOG).

After passing through the threshing and separating assembly, the grain and MOG are deposited onto a grain cleaning system, which may include a plurality of adjustable cleaning sieves, often referred to as a chaffer sieve and a shoe sieve, and sometimes a pre-cleaning sieve. These sieves are typically reciprocated back and forth to separate the grain from the MOG. To further separate the grain from the MOG, a cleaning fan or blower blows air up through the cleaning sieves. This flow of air tends to blow the MOG, which is typically lighter than grain, rearwardly and out the back of the combine. Grain, which is heavier than MOG, is allowed to drop through the openings in the sieve.

The clean grain that falls through the cleaning sieves is deposited on a collection panel positioned beneath the cleaning sieves. The collection panel is angled so as to permit the grain to flow, under the influence of gravity, into an auger trough positioned along the lowermost edge of the collection panel. The auger trough is typically positioned near the forward end of the cleaning sieves and extends along the width of the sieves. The grain collected in the auger trough is then moved by an auger towards the side of the combine where it is raised by a grain elevator and deposited into a storage tank or grain tank.

In order to measure the performance of an agricultural harvester of this kind, and in order to provide information regarding the crop being harvested, prior art yield monitoring systems commonly involved the use of an in-cab display that gave spatially specific yield in bushels per acre overlaid on a map of the field being harvested. Further information regarding yield obtained from the yield monitoring system, such as moisture, flow, and protein content could be displayed separately in numerical format along one edge of the in-cab display. Additionally, information regarding vehicle data, such as ground speed, header height, and elevator speed, could also be displayed separately in numerical format. This information could be displayed numerically or graphically in real time, but not simultaneously and comparatively in real time in graphic format. Instead, the data was shown displayed separately in individual graphs and windows.

Any correlation to be drawn from the relationships between different sets of previously collected data from the yield monitoring system, and from the relationships between previously collected data from the yield monitoring system and previously collected vehicle data, required the operator to observe changes in those values as presented in numerical format or in graphically separate non-comparative windows. Alternately, a user could export the data and analyze it at a later time on an external device using separate software.

What is needed in the art is an in-cab display of a yield monitoring system that would allow an operator to view previously collected data from the yield monitoring system and from the vehicle in graphical format, while allowing the operator to render and display multiple parameters simultaneously and comparatively on the same graph or in the same window, without requiring the user to export the data and analyze it at a later time on an external device using separate software. This would provide a better user experience, and an improved ability to view the performance of the agricultural harvester in terms of correlated data during the harvest.

### SUMMARY OF THE INVENTION

The present invention provides such a way to allow an operator to view previously collected data from the yield monitoring system and from the vehicle in graphical format, while allowing the operator to render and display multiple parameters simultaneously and comparatively on the same graph or in the same window, without requiring the user to export the data and analyze it at a later time on an external device using separate software.

The present invention may receive information previously collected by a number of sensors installed on the agricultural harvester. The information previously collected by the sensors may be displayed in User Defined Windows that allow the user to choose which items of previously collected information are shown and how such previously collected information is displayed. The previously collected information may include, but is not limited to, crop moisture content by percentage, crop yield in bushels per acre, crop rate of flow, protein content of the crop, header height, vehicle speed, and/or grain elevator speed.

The previously collected data to be included in the User Defined Window may be chosen individually, or may be chosen from pre-selected pairs by use of a menu. The previously collected data may be further correlated by the previous fields from which it was collected, by areas within such fields, by time, by global positioning system provided location, and/or by harvested crop variety. The User Defined Windows may be placed in one of a number of existing screen positions, may be placed over existing screen positions, may be made partially transparent over existing screen positions, or may be integrated with existing screens. The present invention may further allow the use of widgets.

The invention in one form is directed to a yield monitoring system for an agricultural harvester. The yield monitoring system has an in-cab display and at least one configurable user defined window operable to display at least two previously collected parameters simultaneously and comparatively in graphical format. The at least two previously collected parameters include previously collected data from at least one yield monitoring sensor or vehicle sensor.

The invention in another form is directed to an in-cab display of a yield monitoring system for an agricultural harvester. The in-cab display has at least one configurable user defined window operable to display at least two previously collected parameters simultaneously and comparatively in graphical format. The at least two previously collected parameters include previously collected data from at least one yield monitoring sensor or vehicle sensor.

The invention in another form is directed to a method of monitoring yield of an agricultural harvester. The method includes several steps. The first step is providing an in-cab display. The second step is viewing at least two previously collected parameters simultaneously and comparatively in graphical format using at least one configurable user defined window. The at least two previously collected parameters include previously collected data from at least one yield monitoring sensor or vehicle sensor.

An advantage of the present invention is that it allows a user to easily draw correlations from the relationships between different sets of previously collected data from the yield monitoring system, and from the relationships between previously collected data from the yield monitoring system and previously collected vehicle data.

Although described herein in terms of its application to combines, embodiments of the present invention are contemplated as applicable to other types of harvesting vehicles, such as grape harvesters, sugar cane harvesters, cotton pickers, hay and forage harvesters, and olive harvesters, as non-limiting examples, which are to be considered “agricultural harvesters,” and to fall within the limits of the appended claims. Additionally, although described herein in terms of its application to self-propelled harvesters, embodiments of the present invention are contemplated as applicable to pull or push type implements, including but not limited to pull type forage harvesters, which are also to be considered “agricultural harvesters,” and to fall within the limits of the appended claims.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a side view of an agricultural harvester;

FIG. 2 is a graphical representation of a prior art yield monitoring system in-cab display;

FIG. 3 is a graphical representation of a yield monitoring system in-cab display according to a first embodiment of the present invention;

FIG. 4 is a graphical representation of a yield monitoring system in-cab display according to a second embodiment of the present invention;

FIG. 5 is a graphical representation of a yield monitoring system in-cab display according to a third embodiment of the present invention; and

FIG. 6 is a graphical representation of a yield monitoring system in-cab display according to a fourth embodiment of the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

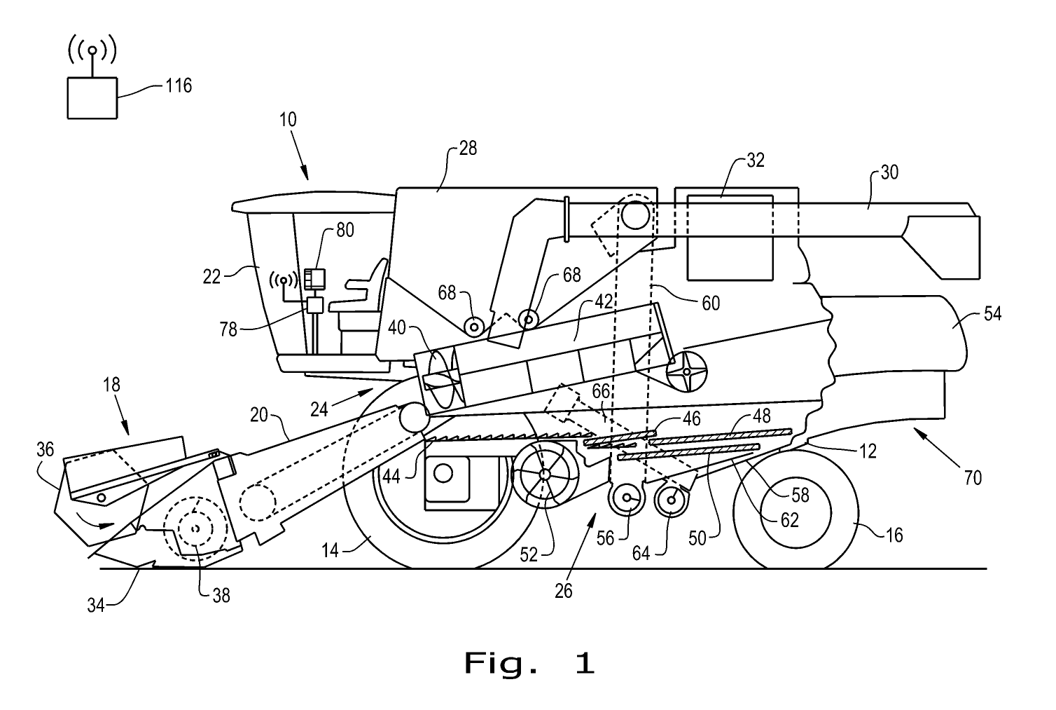

Referring now to the drawings, and more particularly to FIG. 1, there is shown an agricultural harvester in the form of a combine 10, which generally includes a chassis 12, ground engaging wheels 14 and 16, a header 18, a feeder housing 20, an operator cab 22, a threshing and separating system 24, a grain cleaning system 26, a grain tank 28, and an unloading auger 30. It should be appreciated that while the agricultural harvester is shown as combine 10, the agricultural harvester according to the present invention can be any type of construction that allows for crop material to be harvested such as a conventional combine (which does not have a rotor), rotary combine, hybrid combine, chopper harvester, etc. A yield monitoring system 78 having a yield monitoring system in-cab display 80 is provided within the operator cab 22 of the agricultural harvester 10. The yield monitoring system 78 may be wirelessly connected to externally connected module 116.

Front wheels 14 are larger flotation type wheels, and rear wheels 16 are smaller steerable wheels. Motive force is selectively applied to front wheels 14 through a power plant in the form of a diesel engine 32 and a transmission (not shown). Although combine 10 is shown as including wheels, is also to be understood that combine 10 may include tracks, such as full tracks or halftracks. Header 18 is mounted to the front of combine 10 and includes a cutter bar 34 for severing crops from a field during forward motion of combine 10. A rotatable reel 36 feeds the crop into header 18, and an auger 38 feeds the severed crop laterally inwardly from each side toward feeder housing 20. Feeder housing 20 conveys the cut crop to threshing and separating system 24.

Threshing and separating system 24 may include a rotor 40 and a perforated concave 42. The cut crops are threshed and separated by the rotation of rotor 40 within concave 42, and larger elements, such as stalks, leaves and the like are discharged from the rear of combine 10. Smaller elements of crop material including grain and non-grain crop material, including particles lighter than grain, such as chaff, dust and straw, are discharged through perforations of concave 42. Grain which has been separated by the rotor 40 and perforated concaves 42 falls onto a main grain pan 44 and is conveyed toward grain cleaning system 26. Grain cleaning system 26 may include an optional pre-cleaning sieve 46, an upper sieve 48 (also known as a chaffer sieve), a lower sieve 50 (also known as a shoe sieve), and a cleaning fan 52. Grain on sieves 46, 48 and 50 is subjected to a cleaning action by fan 52 which provides an airflow through the sieves to remove chaff and other impurities from the grain by making this material airborne for discharge from straw hood 54 of combine 10. Main grain pan 44 and pre-cleaning sieve 46 oscillate or reciprocate to transport the grain and finer non-grain crop material to the upper surface of upper sieve 48. Upper sieve 48 and lower sieve 50 are vertically arranged relative to each other, and likewise oscillate in a fore-to-aft manner to spread the grain across sieves 48, 50, while permitting the passage of cleaned grain by gravity through the openings of sieves 48, 50.

Clean grain falls to a clean grain auger 56 positioned crosswise below and in front of lower sieve 50. Clean grain auger 56 receives clean grain from each sieve 48, 50 and from bottom pan 58 of grain cleaning system 26. Clean grain auger 56 conveys the clean grain laterally to a generally vertically arranged grain elevator 60 for transport to grain tank 28. Tailings from grain cleaning system 26 fall to a tailings auger on 62. The tailings are transported via tailings auger 64 and return auger 66 to the upstream end of grain cleaning system 26 for repeated cleaning action. A pair of grain tank augers 68 at the bottom of grain tank 28 convey the clean grain laterally within grain tank 28 to unloading auger 30 for discharge from combine 10. The non-grain crop material proceeds through a residue handling system 70. Residue handling system 70 may include a chopper, counter knives, a windrow door and a residue spreader.

The yield monitoring system 78 shown in FIG. 1 receives information from a number of sensors (not shown) installed on the agricultural harvester 10, including quantity of crop yield, moisture content of the crop, rate of flow of the crop into and through the threshing and separating system 24 and cleaning system 26, and protein content of the crop. The yield monitoring system 78 shown in FIG. 1 further receives information from the agricultural harvester 10 such as forward ground speed, speed of operation of the grain elevator 60, and height above the ground of the header 18. Data gathered by the yield monitoring system 78 may be stored and compiled entirely within the yield monitoring system 78, or may be stored and/or compiled partly or jointly by the yield monitoring system 78 and the externally connected module 116.

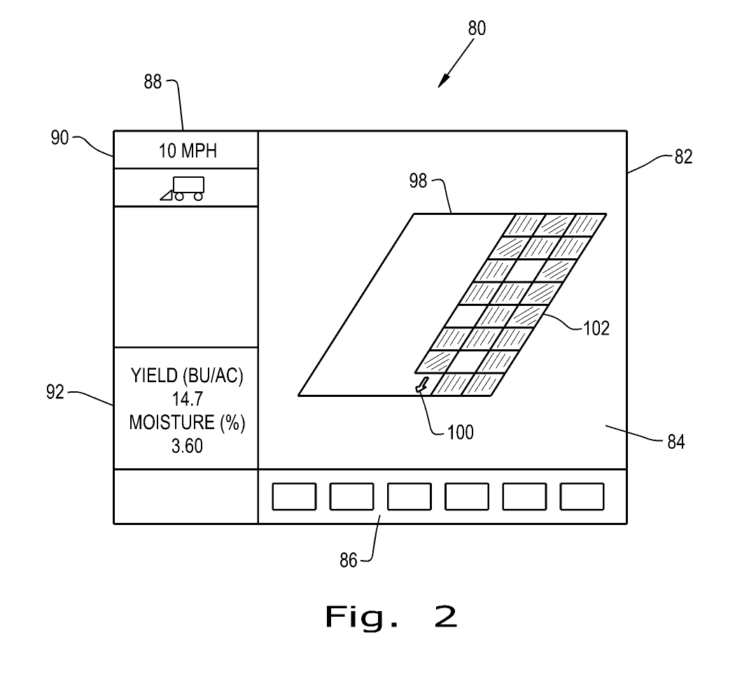

FIG. 2 shows a prior art yield monitoring system in-cab display 80 having a screen 82. The screen 82 is divided into a map display area 84, a graphical operator interface 86, and a configurable left hand screen area 88. The configurable left hand screen area 88 is shown arranged with a vehicle status area 90 and a yield status area 92. The graphical operator interface 86 allows the user to configure certain aspects of the yield monitoring system. The map display area 84 shows a visible map 98 of the field being harvested, with a combine location icon 100 showing the current location of the agricultural harvester 10, and visible indicia 102 of a single characteristic value currently being measured. The yield status area 92 gives certain data taken from the yield monitoring system, in this case yield and moisture content, but only in numerical format, and only separately from vehicle information.

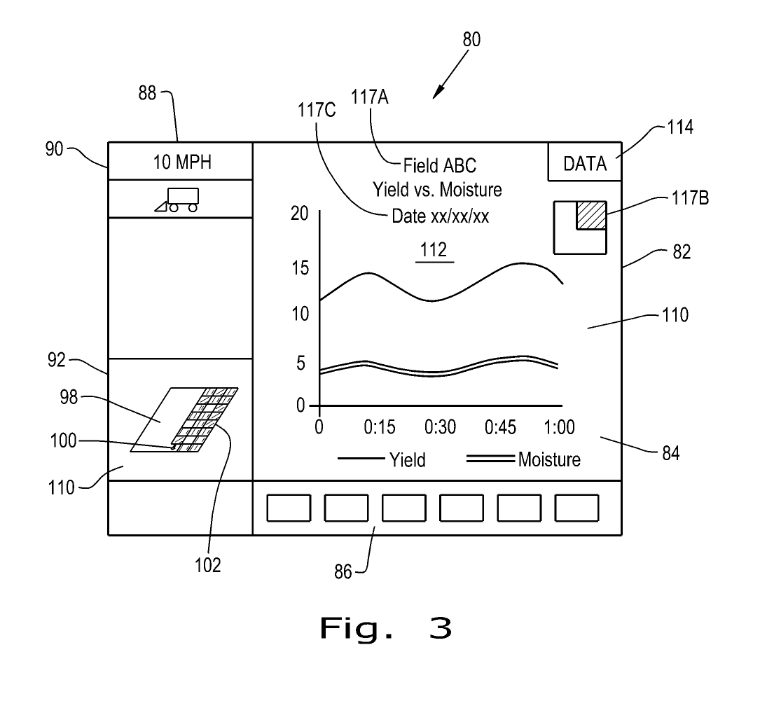

FIG. 3 shows a yield monitoring system in-cab display 80 according to one embodiment of the present invention. The yield monitoring system in-cab display 80 again has a screen 82 divided into a map display area 84, a graphical operator interface 86, and a configurable left hand screen area 88, although this arrangement is shown for illustrative purposes, and other arrangements of these or similar areas is contemplated and within the scope of the invention. The graphical operator interface 86 again allows the user to configure certain aspects of the yield monitoring system. The configurable left hand screen area 88 is still arranged with a vehicle status area 90. However, the yield monitoring system in-cab display 80 shown in FIG. 3 is provided with User Defined Windows (UDW's) 110. These UDW's 110 allow the user to choose which items of information are shown in which portion of the in cab display 80. Using the UDW's 110, the user has chosen to place the visible map 98 in the yield status area 92 location, so that the visible map 98, the combine location icon 100, and the visible indicia of characteristic values 102 are shown in reduced form.

Furthermore, the UDW's 110 allow the user to configure a graphical representation 112 of multiple parameters from data previously collected by the yield monitoring system 78 and/or from the agricultural harvester 10 in relationship to each other. Parameters from data previously collected by the yield monitoring system 78 and/or from the agricultural harvester 10 that may be shown in relationship to each other may include, but are not limited to:
Crop moisture content by percentage and crop yield in bushels per acre. This shows the effect of moisture on yield.
Crop moisture content by percentage and crop rate of flow. This shows the effect of moisture on crop flow.
Header height and crop yield in bushels per acre. This shows the effect of header height on yield.
Header height and crop rate of flow. This shows the effect of header height on crop flow.
Vehicle speed and crop yield in bushels per acre. This shows the effect of the speed of the agricultural harvester on yield.
Vehicle speed and crop rate of flow. This shows the effect of the speed of the agricultural harvester on crop flow.
Grain elevator speed and crop yield in bushels per acre. This shows the effect of the speed of the grain elevator on yield.
Grain elevator speed and crop rate of flow. This shows the effect of the speed of the grain elevator on crop flow.

The previously collected data may further be identified by source indicia 117 such as the field from which it was collected 117A, the area 117B within the field from which it was collected, the time and date 117C it was collected, the global positioning system location 117D where it was collected, and the variety of crop 117E being collected, as non-limiting examples.

In the example shown in FIG. 3, in place of the visible map 98 in the map display area 84, a graphical representation 112 of multiple previously collected parameters has been placed in the map display area 84 and configured to show two previously collected parameters in relationship to each other, in this case crop moisture content by percentage and crop yield in bushels per acre. Further source indicia 117 is provided, including in this case the field 117A from which the data was previously collected, the area 117B within the field from which the data was previously collected, and the date and time 117C when the data was previously collected.

The choice of parameters and source is made available to a user by way of a previously collected data selection menu 114, which may be in the form of a drop-down type menu (not shown) or other expandable selection feature. Similarly, the choice of format of the parameters is also made available to the user by way of the previously collected data selection menu 114, including the type of graph used such as a line chart, column chart, bar chart, area chart, pie chart, scatter chart, or combination chart, as well as line format, color, fill, use of markers, use and format of axis, markers, and legends. Further, the graphical representation 112 of multiple previously collected parameters is shown plotted against time, although the multiple previously collected parameters may also be plotted against area harvested.

The graphical representation 112 may provide the ability to select specific points along the chart for specific comparison of the two parameters at that point, using a cursor or “cross hairs” manipulatable by the user. Additionally, the graphical representation 112 may provide the user with the ability to zoom in or out in order to see specific sections of data. In this way, a proportionate relationship between the previously collected parameters may readily be visualized, and past and present performance of the agricultural harvester 10 analyzed and compared while still in the operator cab 22 of the agricultural harvester 10.

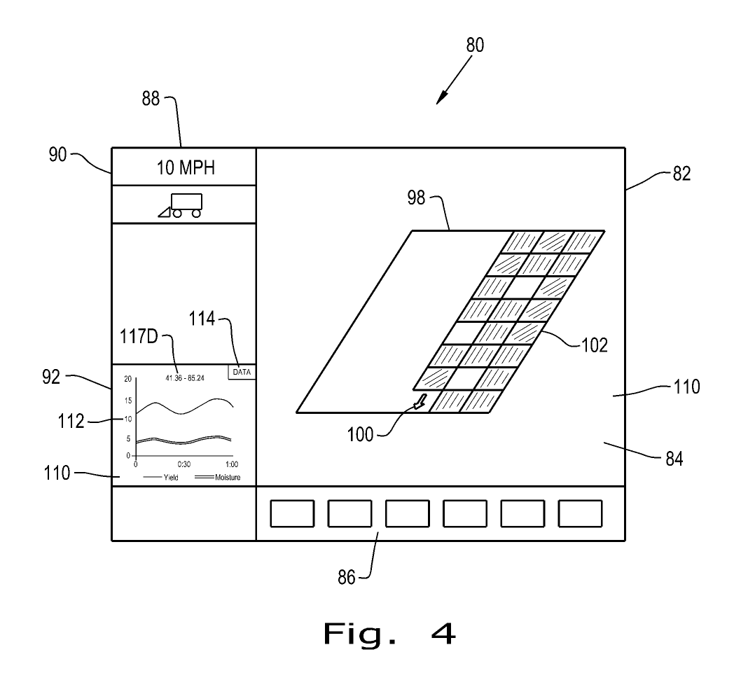

Turning now to FIG. 4, the yield monitoring system in-cab display 80 according to the embodiment of the invention shown in FIG. 3 is shown in a different configuration. The yield monitoring system in-cab display 80 in FIG. 4 is again shown with a screen 82 divided into a map display area 84, a graphical operator interface 86, and a configurable left hand screen area 88. Again, this arrangement is shown for illustrative purposes, and other arrangements of these or similar areas is contemplated and within the scope of the invention. The graphical operator interface 86 again allows the user to configure certain aspects of the yield monitoring system. The configurable left hand screen area 88 is still arranged with a vehicle status area 90. Using the UDW's 110, the user has now chosen to place the visible map 98 in the map display area 84, and has configured the graphical representation 112 of multiple previously collected parameters from the yield monitoring system 78 and/or from the agricultural harvester 10, and has placed the graphical representation 112 in the yield status area 92. The map display area 84 again shows the visible map 98 of the field being harvested, with a combine location icon 100 showing the current location of the agricultural harvester 10, and visible indicia 102 of a single characteristic value currently being measured. The choice of previously collected parameters to display on the graphical representation 112 of multiple previously collected parameters is again made available to the user by way of a data selection menu 114, which may be in the form of a drop-down type menu (not shown) or other expandable selection feature. Further source indicia 117 is provided, including in this case the global positioning system coordinates 117C where the data was previously collected.

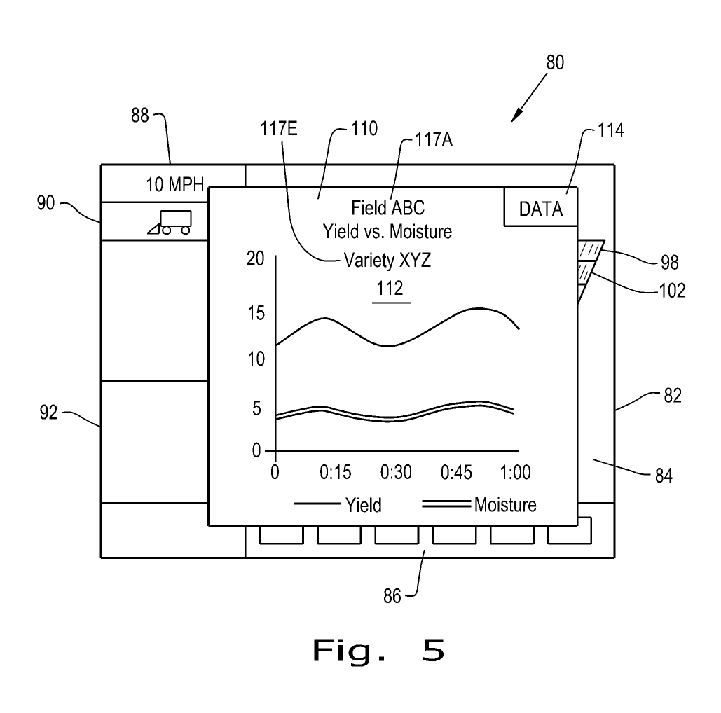

Turning now to FIG. 5, the yield monitoring system in-cab display 80 according to the embodiment of the invention shown in FIGS. 3 and 4 is shown in yet a different configuration. The yield monitoring system in-cab display 80 in FIG. 5 is again shown with a screen 82 divided into a map display area 84, a graphical operator interface 86, and a configurable left hand screen area 88, again for illustrative purposes. The graphical operator interface 86 again allows the user to configure certain aspects of the yield monitoring system. The configurable left hand screen area 88 is still arranged with a vehicle status area 90 and a yield status area 92. Using the UDW's 110, the user has now chosen to place the graphical representation 112 of multiple previously collected parameters generally overlaid over each of the map display area 84, the graphical operator interface 86, and the configurable left hand screen area 88. While portions of the visible map 98 and the visible indicia of characteristic values 102 are still partially visible, the user has chosen to place the graphical representation 112 of multiple previously collected parameters in a prominent position in order to observe the information more readily for a period of time. Again, the choice of previously collected parameters is made available to the user by way of a data selection menu 114. Further source indicia 117 is provided, including in this case the field 117A from which the data was previously collected, and the variety 117E of crop for which data was previously collected.

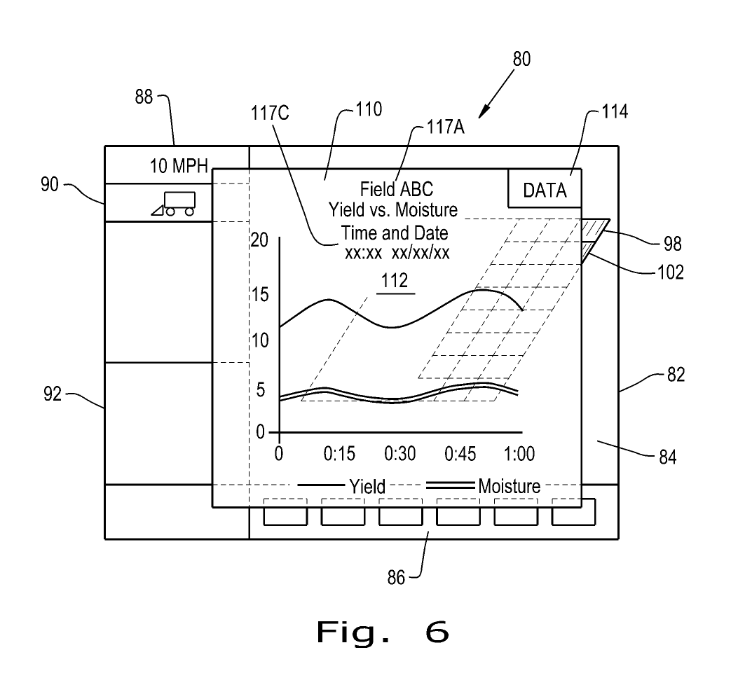

Turning now to FIG. 6, the yield monitoring system in-cab display 80 according to the embodiment of the invention shown in FIGS. 3, 4, and 5 is shown in yet a different configuration. The yield monitoring system in-cab display 80 in FIG. 6 is again shown with a screen 82 divided into a map display area 84, a graphical operator interface 86, and a configurable left hand screen area 88. The graphical operator interface 86 again allows the user to configure certain aspects of the yield monitoring system. The configurable left hand screen area 88 is still arranged with a vehicle status area 90 and a yield status area 92. Using the UDW 110, the user has now chosen to place the graphical representation 112 of multiple previously collected parameters generally overlaid over each of the map display area 84, the graphical operator interface 86, and the configurable left hand screen area 88. The portions of the map display area 84, including parts of the visible map 98 and the visible indicia of characteristic values 102, of the graphical operator interface 86, and of the configurable left hand screen area 88 that are obscured by the UDW 110 are visible through the UDW in ghost outline. Again, the choice of previously collected parameters is made available to the user by way of a data selection menu 114. Further source indicia 117 is provided, including in this case the field 117A from which the data was previously collected, and the time and date 117C when the data was previously collected.

Each of the arrangements of the embodiment of a yield monitoring system in-cab display 80 shown in FIGS. 3, 4, and 5 are shown with UDW's provided by the manufacturer of the yield monitoring system 78 and yield monitoring system in-cab display 80 allowing for the comparison of data from the yield monitoring system 78 and/or from the agricultural harvester 10. However, the yield monitoring system 78 and yield monitoring system in-cab display 80 further makes provision for the use of widgets with similar functionality as the UDW's. Widget for the purposes of this application mean a software application or component made by the present manufacturer or by another entity which can be installed and which provides further functionality or presentation of information. In this case, the further functionality or presentation of information may be graphical representations 112 of the multiple previously collected parameters from the yield monitoring system 78 and/or from the agricultural harvester 10 in relationship to each other, given in other formats or arrangements, including in relationship to the visible indicia 102 of characteristic values shown on the visible map 98. Such widgets may therefore appear as separate windows, similar to the illustrations of the UDW's in FIGS. 3, 4, and 5, or may appear integrated with any of the other display areas such as the map display area 84 or configurable left hand screen area 88.

As noted previously, data gathered by the yield monitoring system 78 may be stored and compiled entirely within the yield monitoring system 78, or may be stored and/or compiled partly or jointly by the yield monitoring system 78 and the externally connected module 116. Furthermore, this data may be recalled to the yield monitoring system in-cab display 80 of the yield monitoring system 78 at any time, either from the memory of the yield monitoring system 78 itself, or from the memory of the externally connected module 116. The operator may recall data from among multiple parameters of previously collected data from the yield monitoring system 78 and from the agricultural vehicle 10 at any time, to be rendered graphically and displayed simultaneously and comparatively on the same graph or in the same window, so that the past performance of the agricultural vehicle 10 may be used as a reference against current performance. This may be done in order to identify ongoing trends over time, and in order to optimize vehicle settings. Further, graphs and reports can be saved to the internal memory of the yield monitoring system 78, the yield monitoring system in-cab display 80, and/or the externally connected module 116, for later usage or for export to further external devices or to a back office machine.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A yield monitoring system for an agricultural harvester, comprising:
an in-cab display; and
at least one configurable user defined window operable to display at least two previously collected parameters simultaneously and comparatively in graphical format, said at least two previously collected parameters including previously collected data from at least one yield monitoring sensor or vehicle sensor.

2. The yield monitoring system of claim 1, wherein:
said previously collected data includes at least one of:
quantity of crop yielded;
moisture content of crop yielded;
rate of flow of crop through the agricultural harvester;
protein content of crop yielded;
ground speed;
speed of operation of a grain elevator; and
height of a header above the ground.

3. The yield monitoring system of claim 1, wherein:
said at least two previously collected parameters being further correlated by at least one source indicia, said at least one source indicia being displayed by said at least one configurable user defined window.

4. The yield monitoring system of claim 3, wherein:
said at least one source indicia includes at least one of:
a field from which said previously collected data was collected;
an area within said field from which said previously collected data was collected;
a time and date said previously collected data was collected;
a global positioning system location where said previously collected data was collected; and
a variety of crop harvested when said previously collected data was collected.

5. The yield monitoring system of claim 1, wherein:
said at least one configurable user defined window being operable to be placed or overlaid over at least one of a map display area, a configurable screen area, and a graphical operator interface area of said in-cab display.

6. The yield monitoring system of claim 5, wherein:
said map display area, configurable screen area, and graphical operator interface area of said in-cab display remaining visible in ghost outline where overlaid by said user defined window.

7. The yield monitoring system of claim 1, wherein:
said at least one configurable user defined window further having a menu, said menu allowing the choice of paired previously collected data sources to be viewed simultaneously and comparatively in graphical format and in real time, including at least one of:
crop moisture content by percentage and crop yield in bushels per acre;
crop moisture content by percentage and crop rate of flow;
header height and crop yield in bushels per acre;
header height and crop rate of flow;
vehicle speed and crop yield in bushels per acre;
vehicle speed and crop rate of flow;
grain elevator speed and crop yield in bushels per acre; and
grain elevator speed and crop rate of flow.

8. The yield monitoring system of claim 1, further comprising:
an external connected module wirelessly connected with said yield monitoring system, said external connected module being operable to store or compile said previously collected data from said at least one yield monitoring sensor or vehicle sensor, and to provide said previously collected data to said in-cab display for use in said display of said at least two previously collected parameters simultaneously and comparatively in graphical format.

9. The yield monitoring system of claim 1, wherein:
said yield monitoring system further allowing the use of a widget as said configurable user defined window.

10. An in-cab display of a yield monitoring system for an agricultural harvester, comprising:
at least one configurable user defined window operable to display at least two previously collected parameters simultaneously and comparatively in graphical format, said at least two previously collected parameters including previously collected data from at least one yield monitoring sensor or vehicle sensor.

11. The in-cab display of claim 10, wherein:
said previously collected data includes at least one of:
quantity of crop yielded;
moisture content of crop yielded;
rate of flow of crop through the agricultural harvester;
protein content of crop yielded;
ground speed;
speed of operation of a grain elevator; and
height of a header above the ground.

12. The in-cab display of claim 10, wherein:
said at least two previously collected parameters being further correlated by at least one source indicia, said at least one source indicia being displayed by said at least one configurable user defined window.

13. The in-cab display of claim 12, wherein:
said at least one source indicia includes at least one of:
a field from which said previously collected data was collected;
an area within said field from which said previously collected data was collected;
a time and date said previously collected data was collected;
a global positioning system location where said previously collected data was collected; and
a variety of crop harvested when said previously collected data was collected.

14. The in-cab display of claim 10, wherein:
said at least one configurable user defined window being operable to be placed or overlaid over at least one of a map display area, a configurable screen area, and a graphical operator interface area of said in-cab display.

15. The in-cab display of claim 10, wherein:
said at least one configurable user defined window further having a menu, said menu allowing the choice of paired previously collected data sources to be viewed simultaneously and comparatively in graphical format and in real time, including at least one of:
crop moisture content by percentage and crop yield in bushels per acre;
crop moisture content by percentage and crop rate of flow;
header height and crop yield in bushels per acre;
header height and crop rate of flow;
vehicle speed and crop yield in bushels per acre;
vehicle speed and crop rate of flow;
grain elevator speed and crop yield in bushels per acre; and
grain elevator speed and crop rate of flow.

16. The in-cab display of claim 10, wherein:
said yield monitoring system further allowing the use of a widget as said configurable user defined window.

17. A method of monitoring yield of an agricultural harvester, comprising the steps of:
providing an in-cab display; and
viewing at least two previously collected parameters simultaneously and comparatively in graphical format using at least one configurable user defined window, said at least two previously collected parameters including previously collected data from at least one yield monitoring sensor or vehicle sensor.

18. The method of claim 17, further comprising the additional steps of:
correlating said at least two previously collected parameters using at least one source indicia; and
displaying said at least one source indicia within said at least one configurable user defined window.

19. The method of claim 17, further comprising the additional steps of:
providing a menu within said at least one configurable user defined window;
allowing the choice of paired previously collected data sources to be viewed simultaneously and comparatively in graphical format using said menu, said previously collected paired data sources including at least one of:
crop moisture content by percentage and crop yield in bushels per acre;
crop moisture content by percentage and crop rate of flow;
header height and crop yield in bushels per acre;
header height and crop rate of flow;
vehicle speed and crop yield in bushels per acre;
vehicle speed and crop rate of flow;
grain elevator speed and crop yield in bushels per acre; and
grain elevator speed and crop rate of flow.

20. The method of claim 17, further comprising the additional step of:
allowing the use of a widget as said configurable user defined window.
